(19) United States
(12) Patent Application Publication
(10) Pub. No.: US 2006/0136301 A1
(43) Pub. Date: Jun. 22, 2006

(54) Transaction processing system and method

(76) Inventor: Flix Grovit, Brussels (BE)

Correspondence Address: SCHWEGMAN, LUNDBERG, WOESSNER & KLUTH, 121 S. 8TH STREET, SUITE 1600, MINNEAPOLIS, MN, 55402, US

(21) Appl. No.: 10/530,369

(22) PCT Filed: Jul. 13, 2001
(86) PCT No.: PCT/GB01/03174

§ 371 Date: Oct. 17, 2005

(30) Foreign Application Priority Data
Jul. 5, 2001 (US) 60303263

(51) Int. Cl. G06Q 99/00; G06Q 20/00

(52) U.S. Cl. 705/16; 705/1

(57) ABSTRACT

The present invention generally relates to a transaction processing system and method for the processing of transactions for goods or services offered in a first currency when physical currency tokens are tendered in a second currency in respect of at least part payment for the goods or services.

The present invention generally relates to a transaction processing system and method for the processing of transactions for goods or services offered in a first currency when physical currency tokens are tendered in a second currency in respect of at least part payment for the goods or services.

The problem of allowing customers and merchants to transact using different currencies is a problem that has been addressed in the prior art primarily with a view to providing electronic transactions using electronic funds associated with customer and merchant accounts. One such system is described in EP-A-0910840. In EP-A-0910840, a central currency conversion transaction server holds a merchant's account and a customer's account in different currencies and is responsible for currency conversion in order to facilitate a transaction. In this way a customer can purchase goods or services in their own currency and this is debited to their account in their own currency. The value of the transaction is credited to the merchant's account in the merchant's currency.

Nowhere in the prior art has the problem of handling cash or cash equivalents been dealt with.

It is therefore an object of the present invention to provide a transaction processing system and method which allows a customer to pay at least in part for goods or services which are offered in a first currency using physical currency tokens in a second currency.

As in accordance with a first aspect of the present invention, there is provided a transaction processing system and method in which a merchant can accept physical currency tokens such as cash, cheques, travellers' cheques, or bankers' drafts in a second currency in at least part payment for goods or services offered for sale in a first currency. When the merchant is offered the physical currency tokens in the second currency, transaction data identifying at least the second currency and the value of the received tokens in transmitted to a currency conversion transaction processor which has access to exchange rate data. At the currency conversion transaction processor the currency conversion is performed and the merchant receives currency conversion transaction data which includes data representing an amount in the first currency which is equivalent to the amount of the received physical currency tokens. The merchant is thus able to complete the transaction for the goods or services using the received currency conversion data and to later receive payment for the received physical currency tokens corresponding to the currency conversion transaction.

In one embodiment of the present invention, the currency conversion transaction data is assigned a transaction identifier to allow the identification of individual transactions to allow required individual payment for transactions to be identified and made to merchants.

The system in accordance with the invention thus provides a simple means by which merchants can accept payment for goods at least in part in a foreign currency. They are able to quickly determine the value of the payment in their local currency and to be assured that the value will be honoured by payment for the physical currency tokens in the merchant's currency. The risks associated with currency exchange rate fluctuations are borne by the provider of the currency conversion system, and not by the merchant or customer. The merchant is guaranteed the exchange rate at the instance of the transaction. Payment to the merchant can either be made by cash equivalent payments e.g. cash, cheques, travellers' cheques, or a bankers' draft, or payment can be effected electronically e.g. by crediting their account at a bank or other financial institution.

The merchant will thus be paid for the received physical currency tokens. Any method by which the merchant disposes of the received physical currency tokens in accordance with the requirements of the currency conversion service provider is encompassed within the scope of the present invention. For example, the physical currency tokens could be collected from the merchant, or the merchant could be required to take or send the physical currency tokens for redemption.

The present invention allows a merchant to accept part payment in a foreign currency for goods or services. The present invention also allows a merchant to accept full and over-payment for goods or services in a foreign currency. In one embodiment of the present invention, the currency conversion transaction processor receives information on the transaction including the cost of the goods or services so that the difference between the cost and the amount in the first currency can be calculated. This information is returned to the merchant to allow the merchant to clearly identify the additional charge in the first currency when part payment is made, or the change be given to the customer in the first currency when over-payment is made in the physical currency tokens in the second currency by the customer.

In one embodiment of the present invention when a merchant is presented with physical currency tokens in a second currency, the merchant can access a database of images of the physical currency tokens in the second currency to aid detection of counterfeit tokens. Information supplementary to the image information can also be given to further aid detection of counterfeit tokens. For example, information on known area of the tokens which make it easier to spot counterfeits can be given together with directions on what to look for.

In one embodiment of the present invention, a security system is provided in which unique identification codes for the received physical currency tokens are input by the merchant as part of the transaction data. At the currency conversion transaction processor a database is provided of unique identification codes for suspect physical currency tokens. The unique identification codes can comprise serial numbers for travellers' cheques, cheques, or for bank notes. The input unique identification codes are checked against the database and a security indicator is generated if the currency conversion transaction processor identifies a problem with the received physical currency tokens. The security indicator is returned in the currency conversion transaction data to the merchant to tell the merchant that the received currency is suspect. Thus this embodiment of the present invention provides an automatic means of detecting suspect currency conversion tokens. The currency conversion tokens can be suspect on the basis that they are known to be counterfeit, stolen, lost, or fraudulent in some other manner.

Another embodiment of the present invention provides a system in which a merchant can access unique identification codes for suspect physical currency tokens to perform a manual check against unique identification codes for received physical currency tokens. This enables the merchant to reliably detect fraud using an up-to-date database of suspect physical currency tokens. The physical currency tokens can be suspect when they are counterfeit tokens, stolen, or lost, otherwise fraudulent.

Since currency conversion is subject to legal restrictions in order to try to prevent money laundering, one embodiment of the present invention provides an automatic detection of the currency transaction or combination of transactions exceeding a threshold. If a currency transaction or combination of transactions exceeds the threshold, the merchant is requested to obtain further information regarding the transaction in order to comply with legal requirements. The information entered by the merchant can then be stored with the currency conversion transaction data. A combination of transactions can be a combination of different currencies each of which can be processed as a different transaction. Alternatively, they can be different transactions on the basis of a return visit to the merchant by a customer which is identified as potentially suspect causing the merchant to consider checking the combination of transactions. The automatic checking of a combination of transactions can be triggered by a merchant who can input one or a number of transaction numbers for previous transactions when entering transaction data for a current transaction. This enables the currency conversion transaction processor -to combine the values of the or each previous transaction and the current transaction in order to check it against the threshold.

The present invention can be implemented using any communication means provided between the merchant and a central processing system providing the currency conversion function. The present invention can thus be implemented over any communications system. A preferred embodiment of the present invention utilizes the Internet which is readily available to merchants and which provides a simple communication path between the providers of the currency conversion function and the merchants. Thus in accordance with this embodiment of the present invention the system can be implemented by providing the merchants with computers implementing web browsers for accessing web pages served by the currency conversion transaction processor.

The present invention can thus be implemented using one or a number of processing systems. The present invention can thus be implemented by suitably programming one or a number of computers. Thus the present invention encompasses computer program code suitable for controlling a processor to implement the method. The computer program can be provided on any suitable carrier medium. The carrier medium can comprise a storage medium such as a floppy disk, hard disk, magnetic tape device, or programmable memory device. Alternatively, the carrier medium can comprise a transient medium such as an electrical, optical, microwave, acoustic, magnetic, electrical, or radio frequency signal. An example of such a signal is an Internet Protocol signal carrying computer code over an Internet Protocol network.

Embodiments of the present invention will now be described with reference to the accompanying drawings in which:

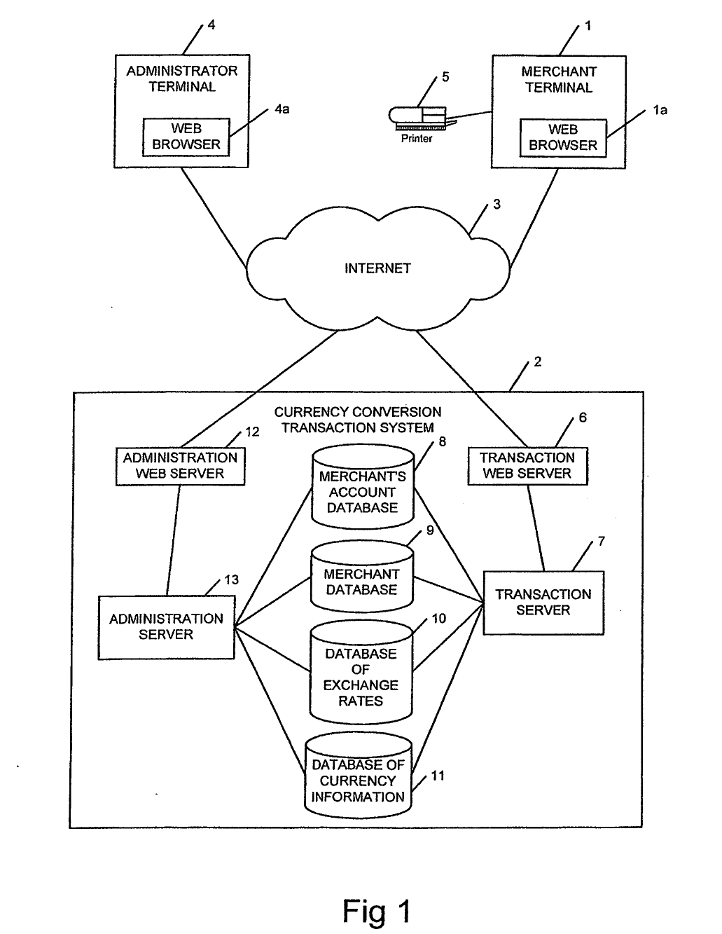

FIG. 1 is a schematic diagram of the transaction processing system in accordance with an embodiment of the present invention;

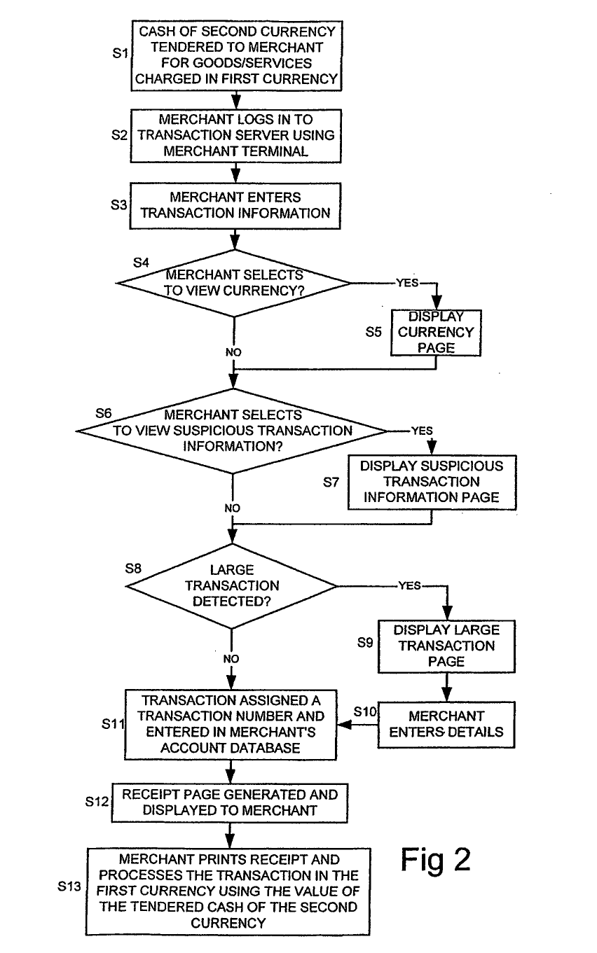

FIG. 2 is a flow diagram of the transaction processing method in accordance with an embodiment of the present invention;

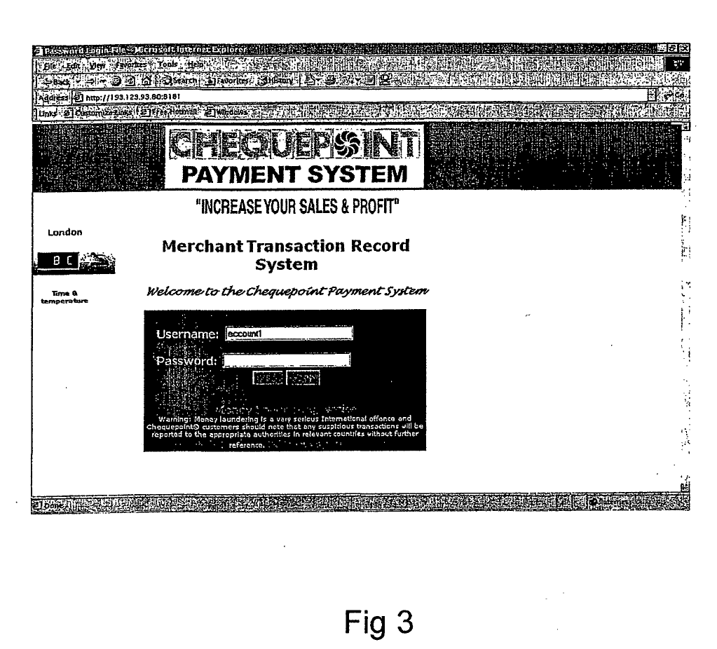

FIG. 3 is a diagram of the display provided to the merchant to allow the merchant to log in to the system;

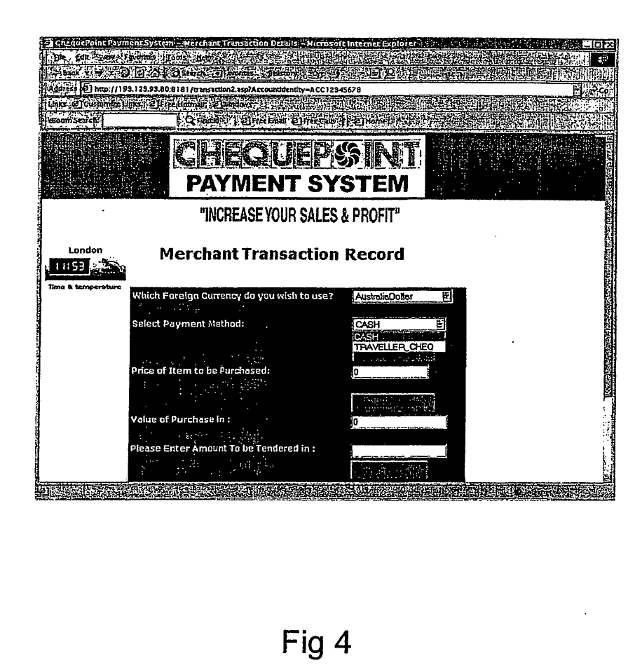

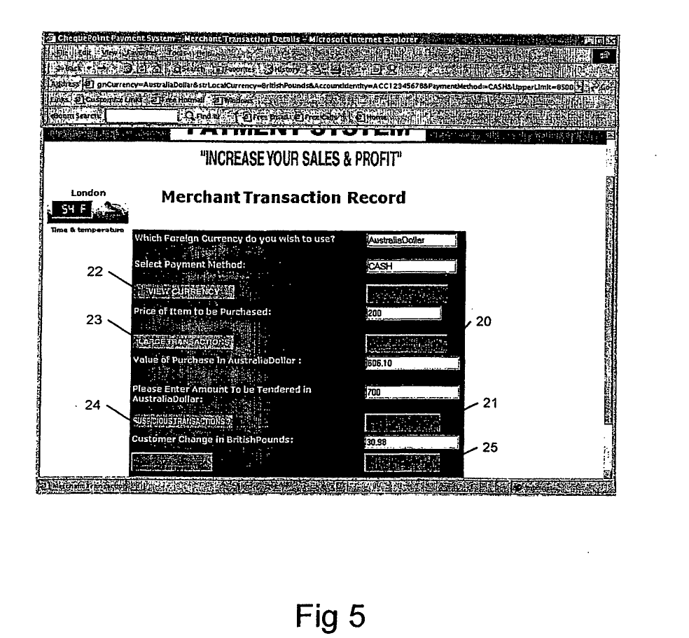

FIG. 4 and FIG. 5 are diagrams illustrating the screen display to allow a merchant to enter data;

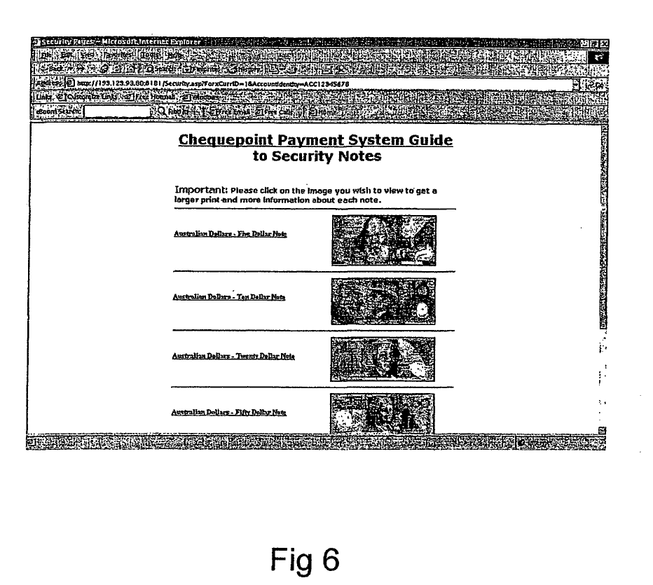

FIG. 6 is a diagram illustrating the screen display to allow the user to obtain information on currencies;

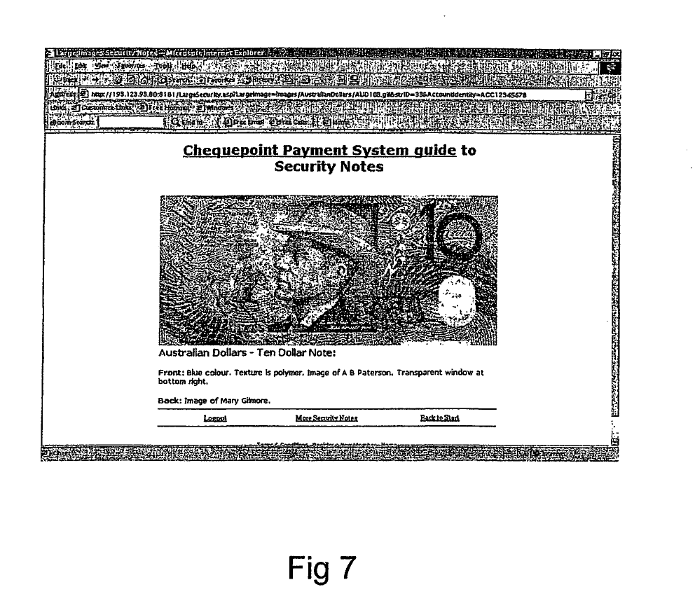

FIG. 7 is a diagram of the screen display providing the merchant with information including an image of a particular currency;

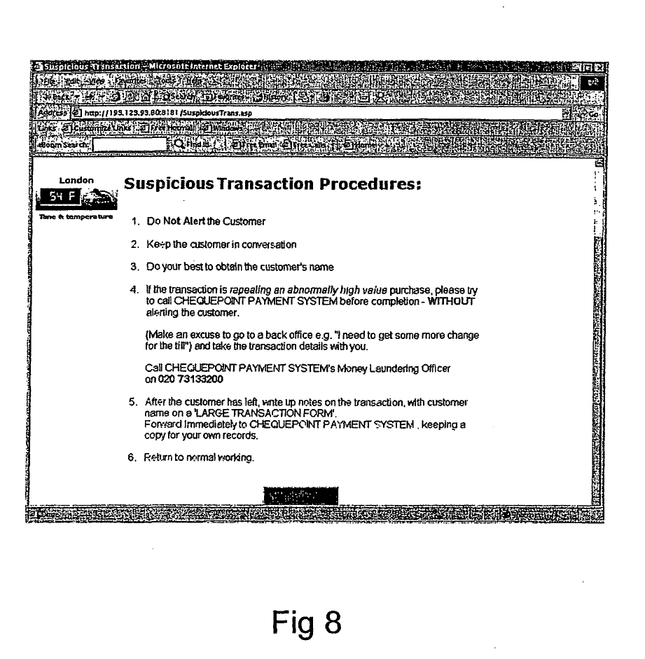

FIG. 8 is a diagram of a screen display providing information on the procedure to follow if the merchant is suspicious;

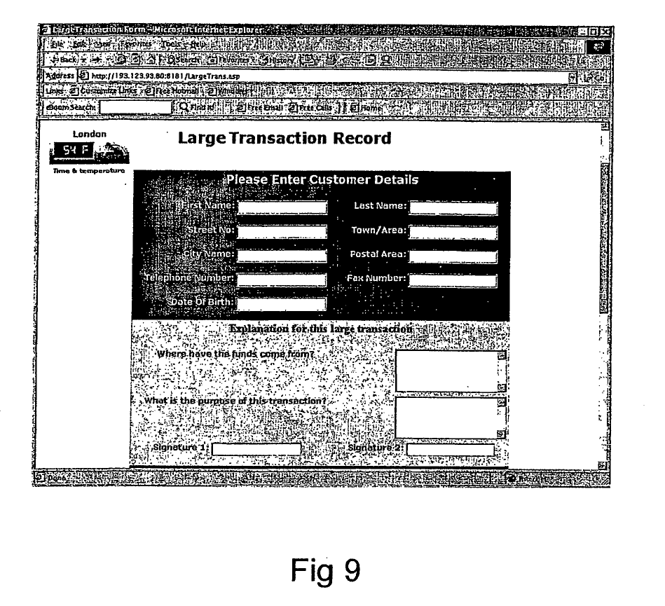

FIG. 9 is a diagram of the screen display requiring a merchant to enter information when the currency conversion transaction processor detects a large transaction; and

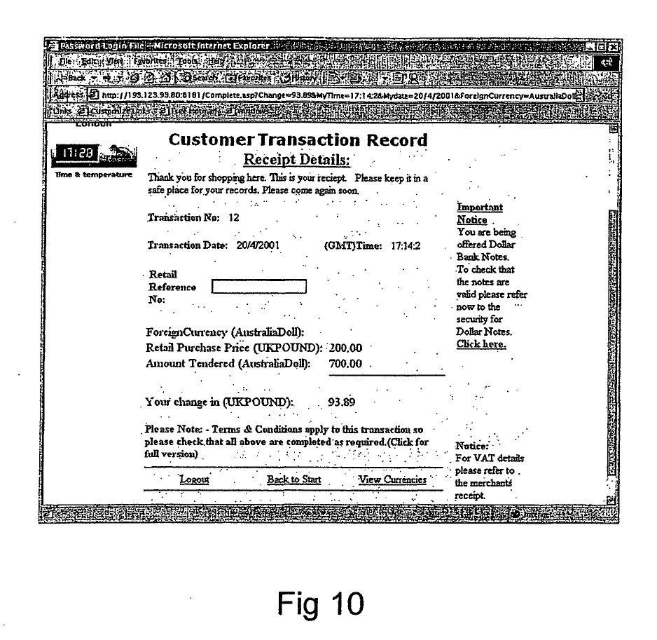

FIG. 10 is a diagram of the screen display providing a printable or faxable transaction receipt for the customer and for the merchant.

Referring to FIG. 1 the transaction processing system comprises a merchant terminal 1 which may comprise any processing apparatus such as a general-purpose computer which can implement a web browser application 1a. The merchant terminal 1 is also provided with a printer 5 for printing out receipts for customers, as will be described in more detail hereinafter. The merchant terminal 1 is connected over the Internet 3 to a currency conversion transaction system 2. The currency conversion transaction system 2 comprises a transaction web server 6 which is accessible by the merchant terminal 1 by use of a suitable universal resource locator (URL) which is served by the transaction web server 6. The transaction web server 6 and the web browser 1a thus provide the user interface for the merchant. A transaction server 7 is provided for performing the transaction function by accessing information stored in a merchant's account database 8, a merchant database 9, a database for exchange rates 10 and a database of currency information 11.

The currency conversion transaction system 2 also includes an administration web server 12 which serves web pages at a different URL to allow an administrator using an administrator terminal 4 implementing a web browser 4a to access administration information served by the administration server 12. An admistration server 13 is provided behind the administration web server 12 to allow an administrator to access the merchant's account database 8, the merchant database 9, the database of exchange rates 10, and the database of currency information 11. Thus a full administrative function is provided separately to the currency conversion transaction function. The administrator is part of the service provider operating the currency conversion transaction system. The currency conversion transaction system 2 of this embodiment of the present invention is a fully web enabled system thus enabling an administrator to access the administrative function via a web page thus providing access over the Internet 3, or over any local Internet Protocol network to which the administration web server 12 can be connected.

The operation of the system will now be described with reference to the flow diagram of FIG. 2. When a customer tenders cash (or cash equivalent) to a merchant in payment or part payment for goods or services and the cash is in a second currency whilst the goods or services are being charged in a first currency (step S1), the merchant uses the web browser application 1a implemented on the merchant terminal 1 to access the transaction web server 6 at the currency conversion transaction system 2 over the Internet 3. FIG. 3 illustrates an example of the display presented to the user as a web page returned to the browser 1a. A user is required to enter their username and password to log in to the transaction server 7 (step S2). The entered username and password is received by the transaction web server 6 and passed on to the transaction server 7 which can look up the merchant username and password in the merchant database 9 to validate the merchant (step S2). The merchant is then presented with the web page illustrated in FIG. 4. This allows the merchant to enter transaction information (step S3). A user can select the currency type which in this case is selected to be Australian Dollars. The user can also select payment type which in this example can either be cash or travellers' cheques. The user can also enter the price of the item to be purchased and the amount tendered by the customer. FIG. 5 illustrates the display when the merchant selects Australian Dollars as the foreign currency and cash is the method of payment. The price of the item to be purchased has been entered as 200 and the local currency, which in this example is Pounds Sterling. The transaction processor determines the value of the purchase in Australian Dollars and outputs this as 606.10 Australian Dollars. The amount tendered by the customer is 700 Australian Dollars and this is entered in the display by the merchant. The transaction processor also calculates the change due in Pounds Sterling and this is displayed to assist the merchant in giving change to the customer in their local currency.

The user is able to request the calculation of equivalents using the “calculate equivalent” button 20 and also request calculation of the changes in the “calculate change” button 21.

It can thus be seen that in this embodiment of the present invention, the merchant is not required to perform any currency conversion calculation. The currency conversion calculation is performed remotely by the transaction server 7 using the exchange rates provided in the database of exchange rates 10. The merchant is thus not only freed from the necessity to perform a calculation, but is also provided with an exchange rate which is fixed at the point of the transaction for the goods or services. The merchant is thus given a guaranteed exchange rate and a guaranteed value for the currency accepted in at least part payment for the goods or services. Thus neither the customer nor the merchant bear the risk associated with subsequent exchange rate fluctuations. The currency conversion service provider implementing the currency conversion transaction system 2 bears exchange rate fluctuation risk.

If a user is unsure of the currency, they can select to view the currency (step S4) by selecting button 22. FIG. 6 illustrates the web page generated by the transaction web server 6 as a result of the selection of the “view currency” button 22. As can be seen in FIG. 6, the merchant is presented with the option to select each of the notes in the foreign currency. FIG. 7 illustrates the screen display when a user has selected the Australian $10 note. The user is provided with a clear image which can show both the front and back of the note together with further information to assist in the identification of counterfeit money. Thus this facility assists the merchant in avoiding fraud and the consequential loss associated with that.

If, when viewing the display of FIG. 5, a merchant selects the “suspicious transactions?” button 24 (step S6) the merchant is presented with the display illustrated in FIG. 8 (step S7). This allows a merchant to obtain more information on the procedures to be followed if they are suspicious.

If, when viewing the merchant transaction record display of FIG. 5, the merchant considers that the transaction is large, or when the merchant selects the “print receipt” button 25, the “large transaction record” display of FIG. 9 is generated either manually when the button 23 is selected by the user, or automatically when the transaction server 7 detects that the transaction is large, i.e. the amount tendered by the customer exceeds a threshold either in the first currency or the second currency. The purpose of the display of FIG. 9 is to require the merchant to enter additional information about the transaction. This is a legal requirement to avoid money laundering. The information entered by the merchant after questioning the customer is received by the transaction server 7 and is stored in the merchant's account database 8 with the transaction record so that this can be referred to at any point if required.

Although in this embodiment it is illustrated that the large transaction is considered to be a single transaction, the present invention encompasses the monitoring of multiple transactions. The merchant can be provided with a window into which previous transaction numbers can be entered for association with the current transaction. This can be used for example when a customer wishes to pay in more than one currency. Each currency can be considered to be a separate transaction but the merchant could wish to indicate that they are related to a single transaction for goods or services. Alternatively, a merchant may recognize a customer revisiting the merchant and may wish to identify a previous transaction by the customer. In this way the aggregate of transactions can be compared to a threshold in order to provide for the automatic detection of suspicious currency transactions. This allows for the automatic generation of the screen requiring additional information which can be stored with the currency transaction record to comply with local legal requirements.

When the transaction data is entered by the user and committed by selecting the “print receipt” button 25, the transaction server 7 receives the data via the transaction web server 6 and assigns the transaction a transaction number in the merchant's account database 8 and a record of the transaction is stored in the merchant's account database 8 (step S11).

A receipt page is then generated by the transaction web server 6 under the direction of the transaction server 7 and this is received by the web browser 1a and displayed to the user as shown in FIG. 10 (step S12). As can be seen in FIG. 10, the receipt includes the transaction number, the transaction date and time, the currency type, the cost of the item or service, the amount tendered by the customer and the change in the local currency of the merchant. The merchant prints the receipt using printer 5 to provide the customer with a receipt and to enable a copy to be kept for their records. The receipt can also be sent by facsimile to a desired recipient. The merchant can then process the transaction for the goods or services using the value of the tendered cash of the second currency. The merchant can thus furnish the customer with change as directed in the receipt, or require further payment in the merchant's local currency to make up the difference when the customer makes a part payment for the goods or services in their currency (step S13).

In the embodiment described hereinabove, the displays are illustrated in the English language since the merchant is located in the United Kingdom. The location of the merchant is stored in the merchant database 9 as a country code. This country code is used by the transaction web server 6 in order to determine the language in which to generate the web pages for the merchant. Thus the language of the user interface provided to the merchant is automatically tailored based on the location of the merchant. Also, the merchant's local currency is automatically determined from the country code. Further, the country code can be used to tailor or modify the information provided to a merchant based on local legal, regulatory, and commercial criteria. The merchant can also be provided with a facility to manually modify their country code and/or country code to modify the user interface as desired.

Referring back to FIG. 1, the database of currency information 11 stores information necessary to provide the displays of FIGS. 6 and 7 to the merchant. It thus stores images of all notes of all currency types together with additional information to aid the detection of counterfeit notes.

The database of exchange rates 10 stores all exchange rate data between all types of currencies to enable the transaction server 7 to determine amounts in first currencies for amounts of physical currency tokens in a second currency offered by customers for goods or services.

The merchant database 9 stores information on merchants. This includes the merchant's password and username necessary for the validation of merchants when the log on to the service. It will also include identification information such as a merchant ID. Further, contact details and bank details for the merchants will be stored. The bank details can be used for payment of the merchant in the first currency for physical currency tokens received in the second currency. The merchant database 9 also stores a country code which is used for identifying the merchant's local currency (first currency). This feature avoids requiring the merchant to enter their local currency in the merchant transaction record interface of FIG. 4. It can also be used to provide localization of the interface to the merchant, i.e. to determine the language to be used in the generation of the web page for the merchant. The merchant database 9 also stores local legal regulatory and commercial information to be used in the tailoring or modification of the information provided to the merchant. The merchant database 9 also stores a zone code for each merchant. The zone code is used for higher resolution localization and is used for customer services purposes and for logistics purposes such as calculating the collection of the physical currency tokens from merchants. The merchant's database 9 also stores information indicating the status of the merchant. The merchant's status can either be active or inactive. A merchant can be put to an inactive status when, for example, their account is unsatisfactory, or they are suspended from using the service for whatever reasons.

The merchant's account database 8 stores all of the transaction information. A currency conversion transaction record for a merchant stores the currency type, e.g. Australian Dollars, the payment type, e.g. cash, cheque, bankers' draft, or travellers' cheque, information on the item or service, the value of the purchase, the amount tendered by the customer in their currency, the customer's change in the merchant's currency, large transaction data, and if the payment type is a travellers' cheque, there is additional travellers' cheque data. When using the interface of FIG. 5 a merchant selects the payment type as traveller's cheque, a further window is displayed requiring the input of additional information comprising a passport number or driver's licence, the identity of the travellers, and a travellers' cheque number or numbers.

Each transaction record in the merchant's account database is given a transaction ID and each merchant has a merchant ID. Thus records of transactions in the account database 8 are linked by transaction ID and merchant ID. The merchant's account database also stores the date and time of the transaction and can store information on the profit margin for the transaction. The profit margin comprises the profit made on the transaction due to the use of differential exchange rates.

The merchant's account database 8 stores total amounts of foreign and local currencies for each merchant. Each transaction stored in the merchant's account database 8 is also given a transaction status. A transaction can have the following statuses:
1. Awaiting collection—in this state the cash has not been collected from the merchant.
2. Collected—in this state it indicates that the cash has been collected from the merchant but has not yet been processed.
3. Valid—this state indicates that the collected cash has been processed and everything is in order.
4. Disputed—in this state it is indicated that although the cash has been collected, there is some problem such as the amount of cash collected does not match the expected amount for the transaction, or there is counterfeit money present in the collected cash.
5. Settled—this state indicates that the merchant has been paid for the collected cash.

The merchant is able to access the transaction server 7 in order to access the merchant's account database 8 in order to look at their accounts records.

It should be noted that when the transaction server 7 passes information to the transaction web server 6 for the generation of the receipt, the information that is output is the transaction ID, the currency type, the value, the amount tendered, and the change. This information is illustrated in the display of FIG. 10. Additionally the merchant can enter their reference in the receipt interactively using the web interface before printing the receipt.

Referring to FIG. 1, it can be seen that an administrator operating the administrator terminal 4 can use the web browser 4a to access the facilities at the administration server 13 via the administration web server 12. This allows an administrator of the currency conversion transaction system 2 to perform full administrative functions on all of the databases 8, 9, 10 and 11. For example, the database of currency information 11 can be updated and modified. Similarly, the database of exchange rates 10 can be updated and modified. Further, the merchant database 9 can be updated and modified as necessary. Further, the administrator can access the account information in the merchant's account database 8. This information allows an administrator to arrange for the physical currency tokens to be collected from the merchant or delivered by the merchant to a collection point. For example, the administrator may monitor the amount of foreign currency in order to determine how regularly to arrange for the collection or delivery of the foreign currency to or from the merchant. Alternatively, the merchant can make individual decisions on individual collections for individual merchants. The administrator can also administer the merchants' accounts to make payments to merchants when transactions reach the valid state so that they can move to the settled state. The administrator can arrange for payments to be made by any conventional means such as by bank transfer, or by delivery of cash in the merchant's local currency. Thus, full access to the databases by an administrator provides for the management of accounts and for a determination of logistics of collection and delivery of the physical currency tokens.

The present invention can also be provided with an additional security function. The currency conversion transaction system 2 can be provided with an additional database storing unique identification codes such as serial numbers for physical currency tokens that are suspect. Physical currency tokens such as bank notes, travellers' cheques, bankers' drafts, etc. can be suspect when they are stolen, lost, or counterfeit for example. A central database either stored at the currency conversion transaction system 2 or accessing remotely to the transaction server 7 can provide an additional security function. For example, the information can be made available to the merchant at the merchant terminal 1. This can be achieved by the transaction web server 6 generating web pages served to the web browser 1a over the Internet 3 to contain up-to-date information on suspect physical currency tokens. This enables the merchant to undertake manual checking of serial numbers when currency and travellers' cheques are received in payment or part payment for goods or services. Alternatively, the currency conversion transaction system 2 can perform an automatic security checking function. When the merchant receives the physical currency tokens, as part of the input information for the transaction record, they can input the serial numbers of the received bank notes, or travellers' cheques. This can then be received by the transaction server 7 and compared with the database of the suspect physical currency tokens. If a match is found, a security notification can be sent back to the merchant to warn them that one or more of the received physical currency tokens are suspect. This allows the merchant to decline the physical currency tokens and to raise a security alarm. Thus the provision of an up-to-date central database of suspect physical currency token information provides for a more secure currency transaction system.

The present invention also provides the ability to enable a merchant to check exchange rates available in the database of exchange rates 10 without committing a transaction. The transaction server 7 can access the database of exchange rate 7 to provide information on exchange rates to the transaction web server 6 to enable the transaction web server 6 to serve web pages to the web browser 1a containing exchange rate information.

Although the present invention has been described hereinabove with reference to specific embodiments, it will be apparent to a skilled person in the art that modifications lie within the spirit and scope of the present invention.

For example, although the embodiments described hereinabove have been described principally with a view to facilitating a purchase of a service or goods, the present invention can extend beyond this function by enabling a merchant to provide for currency exchange solely. If such a fimction is provided, the incentive for using the system is extended beyond merely increasing sales. Commission on currency exchange can provide additional income for the merchant and act as an incentive to increase the amount of currency converted.

The present invention has been described with reference to physical currency tokens. The present invention is applicable to any physical means of payment for goods or services. The physical currency tokens can be any promissory note which is in physical and non-electronic form and which has equivalents to cash.

The present invention allows a merchant to accept payment for goods in any foreign currency and to receive payment in their local currency from a central currency exchange service.

1. A transaction processing method for the processing by a merchant of transactions for goods or services offered in a first currency, the method comprising:
receiving one or more physical currency tokens in a second currency in at least part payment for the offered goods or services;
transmitting transaction data to a currency conversion transaction processor having access to exchange rate data, the transaction data including data identifying at least the second currency and the value of the received tokens;
receiving currency conversion transaction data including data representing an amount in the first currency equivalent to the received physical currency tokens according to the exchange rate data and identification data assigned by the currency conversion transaction processor to identifying the currency conversion transaction;
completing the transaction for the goods or services using the received currency conversion transaction data; and
receiving payment for the received physical currency tokens corresponding to a currency conversion transaction.

2. A transaction processing method according to claim 1, wherein said transaction data includes data identifying the merchant.

3. A transaction processing method according to claim 1, wherein said transaction data includes data identifying the goods or services.

4. A transaction processing method according to claim 1, wherein said transaction data includes data on the cost of the offered goods or services.

5. A transaction processing method according to claim 4, wherein the currency conversion transaction data includes data representing the difference in the first currency between the amount in the first currency equivalent to the received physical currency tokens and the cost of the offered goods or services.

6. A transaction processing method according to claim 1, including displaying the received currency conversion transaction data.

7. A transaction processing method according to claim 1, including transmitting a request for information on the tokens of the second currency, and receiving and outputting images of the tokens of the second currency.

8. A transaction processing method according to claim 7, including receiving and outputting further information on the tokens of the second currency to aid detection of counterfeit tokens.

9. A transaction processing method according to claim 1, wherein the transmission and reception take place over a communications network.

10. A transaction processing method according to claim 9, wherein the transmission and reception take place over the Internet, and the merchant uses a computer running a web browser application.

11. A transaction processing method according to claim 1, including receiving a request for further information about the transaction, and obtaining and transmitting the further information to the currency conversion transaction processor.

12. A transaction processing method according to claim 1, including receiving a currency conversion transaction receipt in the currency conversion transaction data.

13. A transaction processing method according to claim 1, wherein said physical currency tokens each have a unique identification code, said transaction data includes one or more unique identification codes for the or each received physical currency tokens, said received currency conversion transaction data includes a security indicator indicating if the currency conversion transaction processor identified a security problem with the received physical currency tokens from the unique identification code, and displaying a warning to the merchant if a security problem is identified.

14. A transaction processing method according to claim 1, including receiving unique identification codes for physical currency tokens that are suspect from the currency conversion transaction processor to enable the merchant to identify if the received physical currency tokens are suspect.

15. A currency conversion transaction method for allowing merchants offering goods or services in a first currency to accept one or more physical currency tokens of a second currency as at least part payment for the goods or services, the method comprising:
receiving transaction data from a merchant terminal, the transaction data including data identifying at least the second currency and the amount in the second currency of the received physical currency tokens;
assigning identification data to the received transaction data to identify a currency conversion transaction;
determining amount data representing an amount in the first currency equivalent to the amount of the received physical currency tokens of the second currency using exchange rate data;
storing the received transaction data and the amount data as currency conversion transaction data identified by the identification data;
transmitting the currency conversion transaction data to the merchant terminal; and
causing payment to be made of the amount in the first currency according to the stored currency conversion transaction data to the merchant upon redemption of the physical currency tokens of the second currency received by the merchant.

16. A currency conversion transaction method according to claim 15, wherein the received transaction data includes data identifying the merchant.

17. A currency conversion transaction method according to claim 15, wherein the received transaction data includes data identifying the goods or services.

18. A currency conversion transaction method according to claim 15, wherein the received transaction data includes data on the cost of the goods or services.

19. A currency conversion transaction method according to claim 18, including determining the difference in the first currency between the amount in the first currency equivalent to the received physical currency tokens and the cost of the offered goods or services, and storing the determined difference in the currency conversion transaction data.

20. A currency conversion transaction method according to claim 15, including receiving a request for information on the tokens of the second currency, identifying images of the tokens of the second currency in an image store, and transmitting the images to the merchant terminal.

21. A currency conversion transaction method according to claim 20, including identifying further information on the tokens of the second currency and transmitting the further information on the tokens of the second currency to assist the merchant in the detection of counterfeit tokens.

22. A currency conversion transaction method according to claim 15, wherein the transmission and reception take place over a communications network.

23. A currency conversion transaction method according to claim 22, wherein the transmission and reception take place over the Internet, and the method uses a computer running a web server application.

24. A currency conversion transaction method according to claim 15, including detecting when the amount of the currency transaction determined using the amount in the first currency or the amount in the second currency exceeds a threshold, transmitting a request for further information on the transaction to the merchant, receiving the further information and storing the further information in the currency conversion transaction data.

25. A currency conversion transaction method according to claim 15, including receiving identification data for at least one previous transaction related to a current transaction, detecting when the amount of the current currency transaction and the or each previous currency transaction in the first or second currencies exceeds a threshold, transmitting a request for further information on the transaction to the merchant, receiving the further information, and storing the further information in the currency conversion transaction data.

26. A currency conversion transaction method according to claim 15, wherein said physical currency tokens each have a unique identification code, said transaction data includes one or more unique identification codes for the or each received physical currency tokens, identifying if there is a security problem by looking-up the or each unique identification codes in a database of unique identification codes for physical currency tokens known to be suspect, and adding a security indicator to the currency conversion transaction data to indicate if there is an identified security problem with the physical currency tokens.

27. A currency conversion transaction processing system for allowing merchants offering goods or services in a first currency to accept one or more physical currency tokens of a second currency as at least part payment for the goods or services, the processing system comprising:
receiving means for receiving transaction data from a merchant terminal, the transaction data including data identifying at least the second currency and the amount in the second currency of the received physical currency tokens;
assigning means for assigning identification data to the received transaction data to identify a currency conversion transaction;
determining means for determining amount data representing an amount in the first currency equivalent to the amount of the received physical currency tokens of the second currency using exchange rate data;
storing means for storing the received transaction data and the amount data as currency conversion transaction data identified by the identification data;
transmitting means for transmitting the currency conversion transaction data to the merchant terminal; and
payment means for causing payment to be made of the amount in the first currency according to the stored currency conversion transaction data to the merchant upon redemption of the physical currency tokens of the second currency received by the merchant.

28-38. (canceled)

39. A transaction processing terminal for use by a merchant for the processing of transactions for goods or services offered in a first currency when one or more physical currency tokens in a second currency is offered in at least part payment for the offered goods or services, the terminal comprising:
transmitting means for transmitting transaction data to a currency conversion transaction processor having access to exchange rate data, the transaction data including data identifying at least the second currency and the value of the received tokens;
receiving means for receiving currency conversion transaction data including data representing an amount in the first currency equivalent to the received physical currency tokens according to the exchange rate data and identification data assigned by the currency conversion transaction processor to identifying the currency conversion transaction; and
output means for outputting the receiving currency conversion transaction data to allow the merchant to complete the transaction' for the goods or services using the received currency conversion transaction data, and to receive payment for the received physical currency tokens corresponding to a currency conversion transaction.

40-52. (canceled)

53. A transaction processing method for the processing by a merchant of transactions for goods or services offered in a first currency, the method comprising:
receiving one or more physical currency tokens in a second currency in at least part payment for the offered goods or services;
transmitting transaction data to a currency conversion transaction processor having access to exchange rate data, the transaction data including data identifying at least the second currency and the value of the received tokens;
receiving currency conversion transaction data including data representing an amount in the first currency equivalent to the received physical currency tokens according to the exchange rate data; and
completing the transaction for the goods or services using the received currency conversion transaction data.

54. A currency conversion transaction method for allowing merchants offering goods or services in a first currency to accept one or more physical currency tokens of a second currency as at least part payment for the goods or services, the method comprising:
receiving transaction data from a merchant terminal, the transaction data including data identifying at least the second currency and the amount in the second currency of the received physical currency tokens;
determining amount data representing an amount in the first currency equivalent to the amount of the received physical currency tokens of the second currency using exchange rate data;
storing the received transaction data and the amount data as currency conversion transaction data; and
transmitting the currency conversion transaction data to the merchant terminal.

55. A currency conversion transaction processing system for allowing merchants offering goods or services in a first currency to accept one or more physical currency tokens of a second currency as at least part payment for the goods or services, the processing system comprising:
a memory storing processor readable code; and
a processor for reading and implementing the code in the memory;
wherein the processor readable code comprises code for controlling the processor to implement the method of claim 15.

56. (canceled)

57. A transaction processing terminal for use by a merchant for the processing of transactions for goods or services offered in a first currency when one or more physical currency tokens in a second currency is offered in at least part payment for the offered goods or services, the terminal comprising:
a memory storing processor readable code; and
a processor for reading and implementing the code in the memory;
wherein the processor readable code comprises code for controlling the processor to be configured as the processing terminal of claim 39.

58. A carrier medium carrying computer readable code for controlling a computer to implement the method of claim 15.

59-60. (canceled)

61. A security method for use by merchants in transactions for goods or services involving foreign currency, the method comprising:
accessing a database of foreign currency information and selecting information on received foreign currency; and
outputting at least one image of the received foreign currency to aid the detection of counterfeit currency.

62. A security method according to claim 61, including outputting further information useful in detecting counterfeit currency.

63. A security system for use by merchants in transactions for goods or services involving foreign currency, the system comprising:
means for accessing a database of foreign currency information and selecting information on received foreign currency; and
means for outputting at least one image of the received foreign currency to aid the detection of counterfeit currency.

64. A security system according to claim 63, including means for outputting further information useful in detecting counterfeit currency.

65. A security system for use by merchants in transactions for goods or services involving foreign currency, the system comprising:
a memory storing processor readable code; and
a processor for reading and implementing the code in the memory;
wherein the processor readable code comprises code for controlling the processor to implement the method of claim 61.

66. A carrier medium carrying computer readable code for controlling a computer to implement the method of claim 61.

67. A security method for use by merchants in transactions for goods or services involving foreign currency, the method comprising:
submitting unique identification codes for foreign currency to a database containing unique identification codes for suspect currency; and
receiving a notification if the unique identification code matches a unique identification code in the database to warn the merchant that the currency is suspect.

68-70. (canceled)
